(19) United States
(12) Patent Application Publication
(10) Pub. No.: US 2018/0315022 A1
(43) Pub. Date: Nov. 1, 2018

(54) RIDE SHARING MANAGEMENT DEVICE, RIDE SHARING MANAGEMENT METHOD, AND PROGRAM

(71) Applicant: HONDA MOTOR CO., LTD., Tokyo (JP)

(72) Inventors: Seiichi Yamamoto, Tokyo (JP); Naotoshi Fujimoto, Wako-shi (JP)

(21) Appl. No.: 15/947,946

(22) Filed: Apr. 9, 2018

(30) Foreign Application Priority Data
Apr. 26, 2017 (JP) 2017-087690

(51) Int. Cl. G06Q 10/10; G06Q 10/06; G06F 17/30

(52) U.S. Cl. CPC G06Q 10/1095; G06F 17/30979; G06Q 10/06311

(57) ABSTRACT

A ride sharing management device includes a communication unit configured to communicate with a terminal device of a user, an acquisition unit configured to acquire a riding request of the user in which riding conditions including at least a desired boarding place and a desired boarding time are defined, an operation management unit configured to search for a vehicle which can be allocated from operation schedule information, to decide an operation schedule of the vehicle, and to register it in the operation schedule information, and a facility guidance unit configured to refer to a result of the search by the operation management unit and to transmit information on a facility available to a user to a terminal device of the user using the communication unit when the vehicle has not reached the desired boarding place by the time a first predetermined time elapses from the desired boarding time.

### BACKGROUND OF THE INVENTION

### Field of the Invention

The present invention relates to a ride sharing management device, a ride sharing management method, and a storage medium.

### Description of Related Art

Conventionally, an invention of a vehicle common use support device for allowing a plurality of users to use the same common vehicle has been disclosed (refer to Japanese Unexamined Patent Application, First Publication No. 20003-6294). This device includes a database storage unit for storing user information and road information, an estimation processing unit for estimating a traveling route on which a common vehicle travels from a departure place indicated by departure place designation information to an arrival place indicated by arrival place designation information on the basis of the departure place designation information and arrival place designation information received from each user's portable terminal, road information stored in the database storage unit, and current position information from a current vehicle position acquisition unit, and a selection processing unit for searching for a plurality of users eligible for ride sharing in which they board a common vehicle on the basis of an estimated traveling route for each user, selecting a plurality of waiting points on the basis of the ease of reaching them and the ease of waiting at them when a common vehicle reaches a waiting point at the time of executing ride sharing, and prioritizing the plurality of selected waiting points.

### SUMMARY OF THE INVENTION

In the related art, when a user cannot board a vehicle at a desired boarding time, a waiting time occurs, but the related art has no consideration of how to spend a waiting time and is not sufficiently convenient for users.

The present invention has been made in view of such circumstances, and an object thereof is to provide a ride sharing management device, a ride sharing management method, and a storage medium which can improve convenience.

A ride sharing management device, a ride sharing management method, and a storage medium adopt the following configuration.

(1): A ride sharing management device includes a communication unit configured to communicate with a terminal device of a user, an acquisition unit configured to acquire a riding request of the user in which riding conditions including at least a desired boarding place and a desired boarding time are defined, an operation management unit configured to search for a vehicle which can be allocated from operation schedule information on the basis of riding conditions included in the riding request, and to decide an operation schedule of the vehicle and register it in the operation schedule information, and a facility guidance unit configured to refer to a result of the search by the operation management unit and to transmit information on a facility available to the user to a terminal device of the user using the communication unit when the vehicle has not reached the desired boarding place by the time a first predetermined time elapses from the desired boarding time.

(2): In (1), the facility guidance unit transmits information on the facility available to the user to the terminal device of the user using the communication unit when the vehicle has not reached the desired boarding place by the time the first predetermined time elapses from the desired boarding time and the vehicle has reached the desired boarding place by the time a second predetermined time which is longer than the first predetermined time elapses from the desired boarding time.

(3): In (2), the operation management unit transmits information on an alternative transportation means to the terminal device of the user using the communication unit when a vehicle that can reach the desired boarding place by the time the second predetermined time elapses from the desired boarding time is not found.

(4): In (1), when the communication unit receives information indicating the user's agreement to use a facility whose information is transmitted by the facility guidance unit from the terminal device of the user, the operation management unit changes an operation schedule of the vehicle in the operation schedule information to an operation schedule which allows the user to board the vehicle at the facility.

(5): In (1), the ride sharing management device further includes a reward request unit configured to transmit information requesting a reward in accordance with the number of times information of a corresponding facility has been transmitted to the terminal device of the user to a facility terminal used by an administrator of the facility.

(6): In (1), the ride sharing management device further includes a reward request unit configured to transmit information requesting a reward in accordance with the number of times information indicating that the user agrees to use the facility has been obtained from the terminal device of the user to a facility terminal used by an administrator of the facility.

(7): In (1), the ride sharing management device further includes a reward request unit configured to transmit information requesting a reward in accordance with the number of times the user has made payment at a facility or the amount of payment to a facility terminal used by an administrator of the facility.

(8): In (1), the vehicle is an automated driving vehicle.

(9): A ride sharing management method includes acquiring, by a device including a communication unit for communicating with a terminal device of a user, a riding request of the user in which riding conditions including at least a desired boarding place and a desired boarding time are defined, searching for a vehicle which can be allocated from operation schedule information on the basis of riding conditions included in the riding request, determining an operation schedule of the vehicle and registering it in the operation schedule information, referring to a result of the search, and transmitting information on a facility available to the user to the terminal device of the user using the communication unit when the vehicle has not reached the desired boarding place by the time a first predetermined time elapses from the desired boarding time.

(10): A storage medium storing a program which causes a computer of a device including a communication unit communicating with a terminal device of a user to acquire a riding request of the user in which riding conditions including at least a desired boarding place and a desired boarding time are defined, to search for a vehicle which can be allocated from operation schedule information on the basis of riding conditions included in the riding request, to determine an operation schedule of the vehicle and register it in the operation schedule information, to refer to a result of the search, and to transmit information on a facility available to the user to a terminal of the user using the communication unit when the vehicle has not reached the desired boarding place by the time a first predetermined time elapses from the desired boarding time.

According to (1), (9), and (10), a user can use a waiting time of a vehicle meaningfully, and thus it is possible to improve convenience.

According to (2), when a long waiting time occurs, it is possible to provide a moderate service by refraining from providing information.

According to (3), when a long waiting time occurs, it is possible to provide a more practical service by recommending alternative transportation means.

According to (4), a user can smoothly board a vehicle after leaving a facility.

According to (5) to (8), it is possible to realize smooth system operation.

### BRIEF DESCRIPTION OF THE DRAWINGS

FIG. 1 is a configuration diagram of a ride sharing system including a ride sharing management device.

FIG. 2 is a configuration diagram of a vehicle.

FIG. 3 is a diagram for describing a processing process of automatic driving.

FIG. 4 is a diagram which shows an example of content of riding condition information.

FIG. 5 is a diagram which shows an example of content of facility information included in map information.

FIG. 6 is a diagram which shows an example of content of operation schedule information.

FIG. 7 is a flowchart which shows an example of a flow of processing executed by a ride sharing management device.

FIG. 8 is a flowchart which shows an example of the flow of the processing executed by the ride sharing management device.

FIG. 9 is a diagram which shows an example of a screen IM1 displayed on a terminal device.

FIG. 10 is a diagram which shows an example of a screen IM2.

FIG. 11 is a diagram which shows an example of a screen IM3.

FIG. 12 is a diagram which shows an example of a screen IM4.

FIG. 13 is a diagram which shows an example of a screen IM5.

FIG. 14 is a diagram which shows an example of content of aggregate information for a reward.

### DETAILED DESCRIPTION OF THE INVENTION

Hereinafter, embodiments of a ride sharing management device, a ride sharing management method, and a storage medium of the present invention will be described with reference to the drawings. The ride sharing management device is a device for supporting use of one or more vehicles by a plurality of users in common (ride sharing). Vehicles used for ride sharing are, for example, automated driving vehicles which require essentially no driving operation. Hereinafter, an automated driving vehicle will be described as being used for ride sharing, but a manual driving vehicle can also be used.

When a riding request is acquired by communication from a terminal device of a user, a ride sharing management device searches for a vehicle that meets riding conditions defined in the riding request (a vehicle which can be allocated). The communication may include both data communication and voice communication, that is, telephone.

Moreover, the ride sharing management device provides the user with guidance information on how to spend a waiting time when a vehicle meeting the riding conditions is not found. As a result, it is possible to improve convenience for the user.

[Overall Configuration]

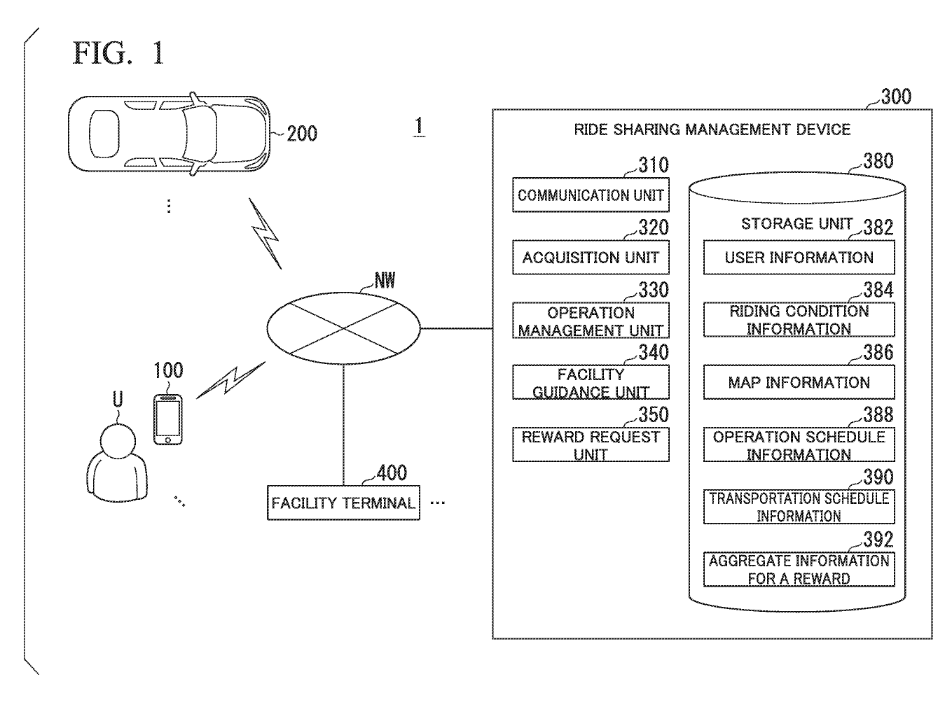

FIG. 1 is a configuration diagram of a ride sharing system 1 including a ride sharing management device 300. The ride sharing system 1 includes one or more terminal devices 100 used by one or more users U, one or more vehicles 200, the ride sharing management device 300, and one or more facility terminals 400. These configuration elements can communicate with each other via a network NW. The network NW includes the Internet, a wide area network (WAN), a local area network (LAN), a public line, a provider device, a dedicated line, a radio base station, and the like. “Being used by a user U” may also mean that a terminal device such as a terminal device in a net café which can be used by a number of unspecified users is temporarily used by a user U.

[Terminal Device]

The terminal device 100 is, for example, a smart phone, a tablet terminal, a personal computer, or the like. In the terminal device 100, an application program for using a ride sharing system, a browser, or the like is started to support a service to be described below. In the following description, it is assumed that the terminal device 100 is a smart phone and an application program (ride sharing application) is started. The ride sharing application communicates with the ride sharing management device 300 according to an operation of the user U, and transmits a request of the user U to the ride sharing management device 300 or performs push notification based on information received from the ride sharing management device 300.

[Vehicle]

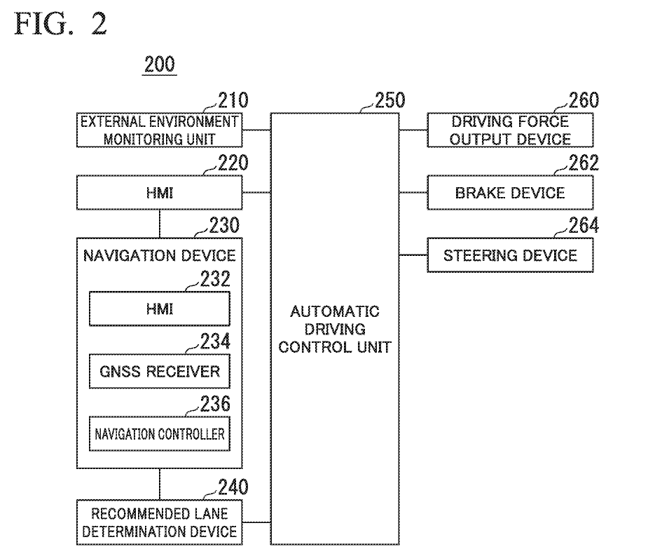

The vehicle 200 is, for example, a vehicle having four or more wheels in which a plurality of users U can ride, but may be a motorcycle or another vehicle. FIG. 2 is a configuration diagram of the vehicle 200. The vehicle 200 includes, for example, an external environment monitoring unit 210, a communication device 220, a navigation device 230, a recommended lane determination device 240, an automatic driving control unit 250, a driving force output device 260, a brake device 262, and a steering device 264.

The external environment monitoring unit 210 includes, for example, a camera, radar, light detection and ranging (LIDAR), an object recognition device which performs sensor fusion processing on the basis of an output of these, and the like. The external environment monitoring unit 210 estimates types of objects in the periphery of the vehicle 200 (in particular, vehicles, pedestrians, and bicycles), and outputs them to the automatic driving control unit 250 along with information on positions or speeds thereof.

The communication device 220 is, for example, a wireless communication module for connecting to the network NW or for directly communicating with other vehicles, terminal devices of pedestrians, or the like. The communication device 220 performs wireless communication on the basis of Wi-Fi, dedicated short range communications (DSRC), Bluetooth (registered trademark), and other communication standards. As the communication device 220, a plurality of wireless communication modules according to an application may be prepared.

The navigation device 230 includes, for example, a human machine interface (HMI) 232, a global navigation satellite system (GNSS) receiver 234, a navigation controller 236, and the like. The HMI 232 includes, for example, a touch panel type display device, a speaker, a microphone, and the like. The GNSS receiver 234 measures a position of the vehicle 200 on the basis of electric waves coming from the GNSS satellite (for example, a GPS satellite). The navigation controller 236 includes, for example, a central processing unit (CPU) and various types of storage devices, and controls the entire navigation device 230. The storage devices store map information (a navigation map). The navigation map is a map expressing roads using nodes and links. The navigation controller 236 determines a route from the position of the vehicle 200 measured by the GNSS receiver 234 to a destination designated using the HMI 232 with reference to the navigation map. The navigation controller 236 may transmit the position of the vehicle 200 and the destination to a navigation server (not shown) using the communication device 220, and acquire a route returned from the navigation server. In the case of the present embodiment, the route to a destination may be designated by the ride sharing management device 300. The route may include information on a point at which to stop to allow a user to board or exit a vehicle and a target arrival time. The navigation controller 236 outputs information on a route determined using any one of the methods described above to the recommended lane determination device 240.

The recommended lane determination device 240 includes, for example, a micro processing unit (MPU) and various types of storage devices. The storage devices store map information with high accuracy in more detail than the navigation map. The map information with high accuracy includes, for example, information on a road width, slope, curvature, or a signal position for each lane. The recommended lane determination device 240 determines a preferable recommended lane to travel along a route input from the navigation device 230, and outputs the determined lane to the automatic driving control unit 250.

The automatic driving control unit 250 includes one or more processors such as CPUs, MPUs, or the like and various types of storage devices. The automatic driving control unit 250 automatically causes the vehicle 200 to travel the recommended lane determined by the recommended lane determination device 240 in principle to avoid contact with an object whose position and speed are input from the external environment monitoring unit 210. The automatic driving control unit 250 sequentially executes, for example, various types of events. The events include a constant-speed travel event in which a vehicle travels in the same traveling lane at a constant speed, a following travel event in which a vehicle follows a vehicle traveling ahead of it, a lane change event, a merging event, a branching event, an emergency stop event, a tollgate event for passing through a tollgate, a handover event for ending automatic driving and switching to manual driving, and the like. While these events are executed, actions for avoidance may be planned on the basis of a peripheral situation of the vehicle 200 (the presence of nearby vehicles and pedestrians, lane narrowing caused by road construction, and the like) in some cases.

The automatic driving control unit 250 generates a target trajectory in which the vehicle 200 will travel in the future. The target trajectory includes, for example, a speed element. For example, the target trajectory is expressed as a sequential arrangement of points (trajectory points) to be reached by a host vehicle M. The trajectory points are points to be reached by the host vehicle M at each predetermined traveling distance. Apart from this, a target speed and a target acceleration for each predetermined sampling time (for example, about several tenths of a [sec]) are generated as a portion of the target trajectory. The trajectory points may be positions to be reached by the host vehicle M at the sampling time for each predetermined sampling time. In this case, the information on the target speed and target acceleration is expressed by an interval between trajectory points.

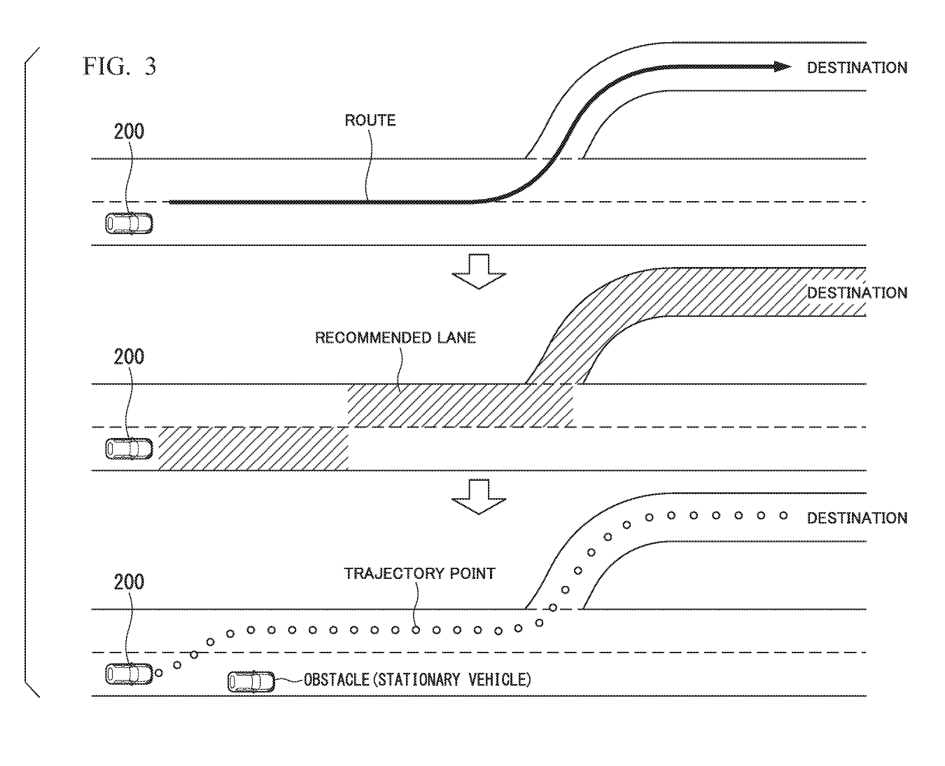

FIG. 3 is a diagram for describing a processing process of automatic driving. First, a route is determined by the navigation device 230 as shown in FIG. 2. This route is, for example, a rough route with no lane distinction. Next, as shown in the middle of FIG. 3, the recommended lane determination device 240 determines a recommended lane that is easy to travel along the route. Then, as shown in the lower FIG. 3, the automatic driving control unit 250 generates trajectory points to travel along a recommended lane as much as possible while avoiding obstacles, and controls some or all of the driving force output device 260, the brake device 262, and the steering device 264 such that the vehicle travels along the trajectory points (and accompanying speed profile). Such role sharing is merely an example, and for example, the automatic driving control unit 250 may perform processing in an integrated manner.

The driving force output device 260 outputs a traveling driving force (torque) for traveling of the vehicle to driving wheels. The driving force output device 260 includes, for example, a combination of an internal combustion engine, an electric motor, a transmission, and the like, and a power ECU for controlling these. The power ECU controls the above configuration according to information input from the automatic driving control unit 250 or information input from a driving operator that is not shown.

The brake device 262 includes, for example, a brake caliper, a cylinder which transmits hydraulic pressure to the brake caliper, an electric motor which generates hydraulic pressure in the cylinder, and a brake ECU. The brake ECU controls an electric motor according to information input from the automatic driving control unit 250 or information input from a driving operator such that brake torque in accordance with the control operation is output to each wheel. The brake device 262 may include a mechanism that transmits hydraulic pressure generated by an operation of a brake pedal included in a driving operator to the cylinder via a master cylinder as a backup. The brake device 262 is not limited to the configuration described above, and may be an electronic control type hydraulic pressure brake device which controls an actuator according to the information input from the automatic driving control unit 250 and transmits hydraulic pressure of a master cylinder to a cylinder.

The steering device 264 includes, for example, a steering ECU and an electric motor. The electric motor changes a direction of a steering wheel by, for example, operating a force in a rack and pinion mechanism. The steering ECU drives the electric motor according to the information input from the automatic driving control unit 250 or the information input from a driving operator, and changes the direction of a steering wheel.

[Ride Sharing Management Device]

Returning to FIG. 1, the ride sharing management device 300 includes, for example, a communication unit 310, an acquisition unit 320, an operation management unit 330, a facility guidance unit 340, a reward request unit 350, and a storage unit 380.

The communication unit 310 is, for example, a network card for connecting to the network NW. The storage unit 380 is realized by a hard disk drive (HDD), a flash memory, a random access memory (RAM), a read only memory (ROM), or the like. The communication unit 310 communicates with the terminal device 100 or the vehicle 200 via the network NW.

The acquisition unit 320, the operation management unit 330, the facility guidance unit 340, and the reward request unit 350 are realized by executing, for example, a program (software) stored in the storage unit 380. Some or all of these functional units may be realized by hardware such as large scale integration (LSI), an application specific integrated circuit (ASIC), a field-programmable gate array (FPGA), or the like, and may also be realized by software and hardware in cooperation. The program may be stored in a storage device such as an HDD or a flash memory in advance, and may also be stored in a detachable storage medium such as a DVD or a CD-ROM and may be installed in a storage device by the storage medium being mounted on a drive device.

The acquisition unit 320 acquires a riding request issued from the terminal device 100 of a user via the communication unit 310 and the network NW, and registers riding conditions included in the riding request in the storage unit 380 as riding condition information 384. User information 382 includes personal information on a service applicant A, a service user U, a service provider S, and the like.

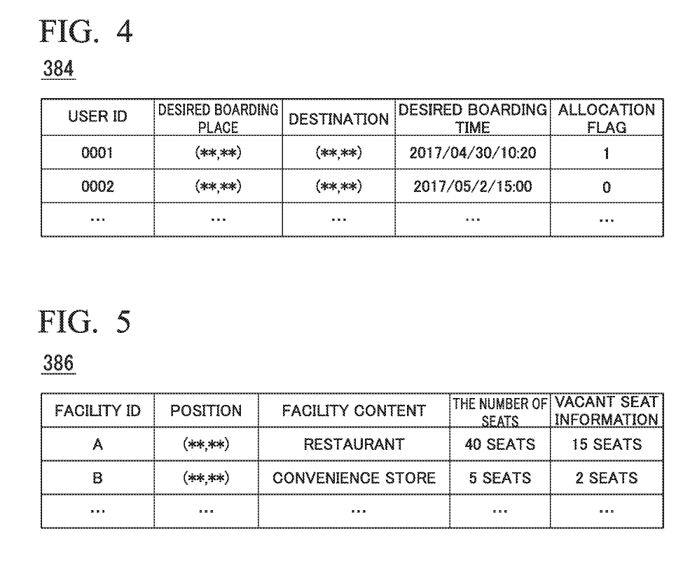

FIG. 4 is a diagram which shows an example of content of the riding condition information 384. As shown in FIG. 4, the riding condition information 384 is information in which a desired boarding place, a destination, a desired boarding time, an allocation flag which indicates whether allocation is determined (for example, 1 indicates that allocation is determined, and 0 indicates that allocation is not determined), and the like are correlated with a user ID which is identification information of a user registered in advance. Content of information other than the allocation flag is determined by a ride sharing application of the terminal device 100 receiving an input of a user, and the content is transmitted to the ride sharing management device 300 as a riding request. Hereinafter, a series of information correlated with one user ID in the riding condition information 384 may be referred to as a “record” in some cases.

The operation management unit 330 refers to the riding condition information 384, map information 386, and operation schedule information 388, and searches for a vehicle 200 which can be allocated. The map information 386 includes facility information indicating an outline of various types of facilities in addition to information on nodes and links (such information may also be included in the navigation map or a high-accuracy map of the vehicle 200). FIG. 5 is a diagram which shows an example of content of facility information included in the map information 386. The facility information is information in which, for example, a position, facility content, the number of seats, vacant seat information, and the like are correlated with a facility ID which is identification information of a facility. This facility is, for example, a facility affiliated with an operator of the ride sharing system 1, and is preferably a facility having seats such as a café. It is preferable that seats exclusively for users of the ride sharing system 1 be provided in the facility or that a discount service for the users of the ride sharing system 1 be provided. The number of seats or vacant seats is transmitted to the ride sharing management device 300 from a facility terminal 400 which is a terminal of the facility when necessary.

For example, the operation management unit 330 coarsely groups time zones and traveling sections from a desired boarding place to a destination place among records included in the riding condition information 384, and moreover, extracts one or more records associated with one or more users who can be carried by one vehicle 200 and registers them in the storage unit 380 as portions of the operation schedule information 388.

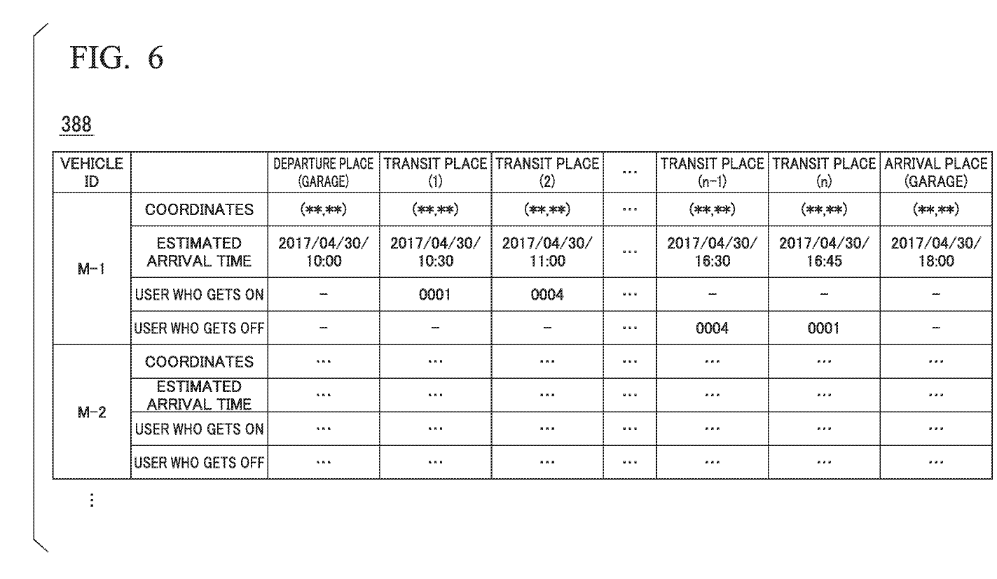

FIG. 6 is a diagram which shows an example of content of the operation schedule information 388. As shown in FIG. 6, the operation schedule information 388 is information in which coordinates of each of a departure place, a transit place, and an arrival place, an estimated arrival time of the vehicle 200, a user ID of a user who boards the vehicle 200, and a user ID of a user who exits at each transit place are correlated with a vehicle ID which is identification information of the vehicle 200 managed by the ride sharing management device 300. The departure place or arrival place is usually a garage or the like. Information on an “empty vehicle” whose operation schedule has not been determined yet is also registered in the operation schedule information 388. In this case, only coordinates of a departure place are registered for an empty vehicle. The operation management unit 330 may determine the operation schedule of one vehicle 200 by collecting riding requests from a plurality of users as described above, and may search for an operation schedule which is already determined and change the operation schedule to include another user's riding request. That is, the operation management unit 330 may search for a vehicle 200 whose operation schedule has not been determined, or may search for an operation schedule which can include a riding request of a user in the operation schedule of the vehicle 200 which has already been determined. The operation management unit 330 transmits information on a route (transit place) and an assumed passage time to the vehicle 200 on the basis of the operation schedule information 388 at a predetermined timing. The operation management unit 330 notifies a terminal device or a vehicle terminal device of the driver of a vehicle 200 of a request to change a riding request when the vehicle 200 is a manual driving vehicle.

When an operation schedule is determined, the operation management unit 330 determines to allow the user to board a vehicle when the vehicle cannot reach a desired boarding place by a desired boarding time but can reach the desired boarding place between the desired boarding time and a maximum delay time TD2 (an example of a second predetermined time). On the other hand, when the vehicle 200 cannot reach the desired boarding place without exceeding a maximum delay time TD2 from the desired boarding time, the operation management unit 330 refers to transportation schedule information 390 and transmits information on an alternative transportation system to the terminal device 100 of the user. Specifically, the operation management unit 330 extracts stations, bus stops, and the like which are close to each of a desired boarding position and a destination from the map information 386, and acquires a shortest movement means connecting them by referring to the transportation schedule information 390.

The facility guidance unit 340 refers to a result of the search by the operation management unit 330 (more specifically, the operation schedule information 388) and determines whether there is a case in which a vehicle cannot reach a desired boarding place by a desired boarding time, but can reach the desired boarding place between a facility guidance reference time TD1 (an example of a first predetermined time) that elapses from the desired boarding time and a time not exceeding a maximum delay time TD2. The facility guidance unit 340 transmits information on an available facility of a corresponding user to the terminal device 100 of the user when there is such a case. Cases of “cannot reach (not reachable)” include a case in which there is no vehicle which can reach the desired boarding place before a first predetermined time elapses from the desired boarding time at the time of searching for a vehicle 200, and a case in which a reserved vehicle 200 is delayed due to traffic conditions and the like and has a decreased possibility of reaching the desired boarding place before the first predetermined time elapses from the desired boarding time. That is, the facility guidance unit 340 may dynamically transmit information on a facility available to a corresponding user to the terminal device 100 of the user in accordance with the delay of the vehicle 200, not only at the time of searching for the vehicle 200 but also after the vehicle 200 starts an operation.

In response to this, when information on an agreement to use a facility is returned from the terminal device 100 of the user, the facility guidance unit 340 notifies the operation management unit 330 of this and changes the desired boarding place of a corresponding user to the position of the facility. At this time, the operation management unit 330 may correct the desired boarding time of the corresponding user in the operation schedule information 388 in accordance with an estimated arrival time. With the above processing, the user can board a vehicle 200 smoothly after spending a waiting time at the facility.

[Processing Flow/Example Scenarios]

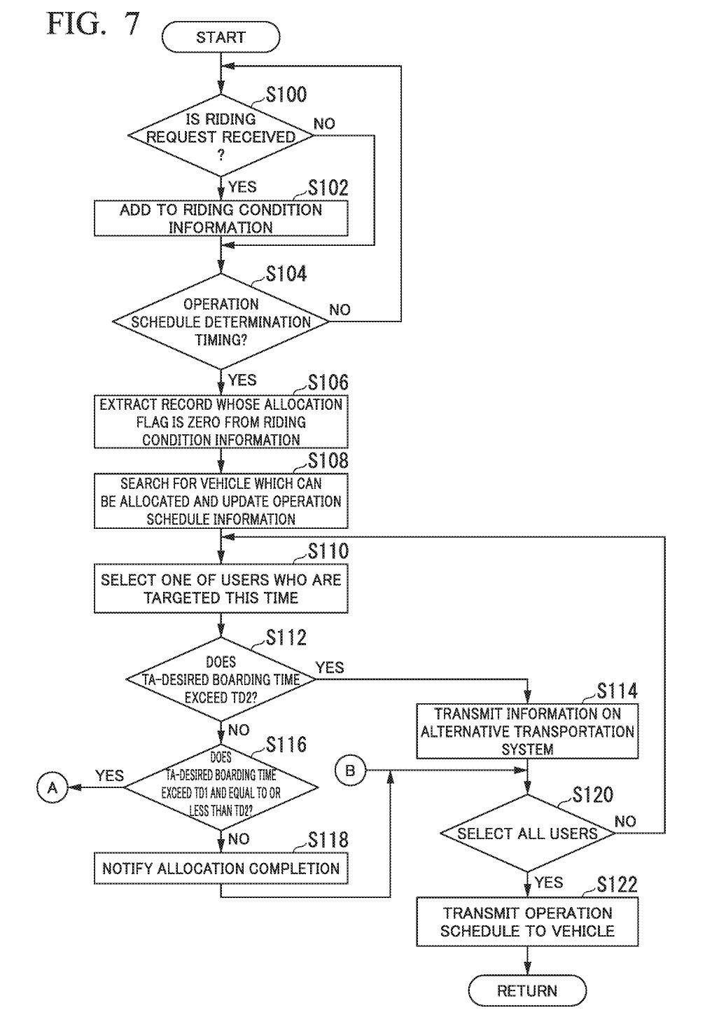

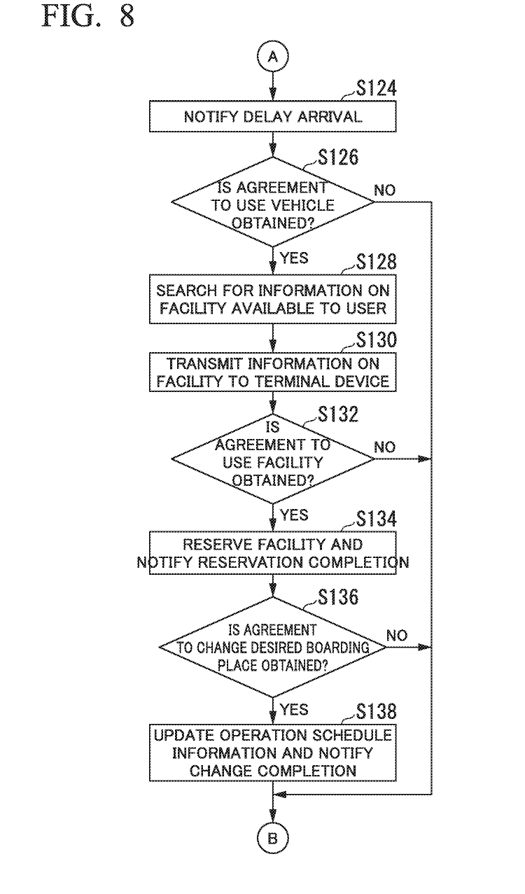

FIGS. 7 and 8 are flowcharts which show examples of a flow of processing executed by the ride sharing management device 300. First, the ride sharing management device 300 determines whether a riding request has been received from the terminal device 100 (step S100). If a riding request is received from the terminal device 100, the ride sharing management device 300 adds riding conditions included in the riding request to the riding condition information 384 (step S102).

Next, the ride sharing management device 300 determines whether an operation schedule determination timing has arrived (step S104). When an operation schedule determination timing has not arrived, the processing returns to step S100. An operation schedule determination timing can be arbitrarily determined, but, for example, may be determined to arrive with predetermined time (for example, about 10 minutes) intervals during an operation time of the ride sharing system 1.

If the operation schedule determination timing arrives, the ride sharing management device 300 extracts a record whose allocation flag is 0 from the riding condition information 384 (step S106). Next, the ride sharing management device 300 searches for a vehicle 200 which can be allocated and updates the operation schedule information 388 on the basis of a result of the search (step S108).

Next, the ride sharing management device 300 selects one of users who are targeted this time (users associated with records extracted in step S106) (step S110). Then, the ride sharing management device 300 refers to the riding condition information 384 and the operation schedule information 388, and determines whether a difference obtained by subtracting a desired boarding time from an estimated arrival time TA of a vehicle 200 allocated to a corresponding user exceeds a maximum delay time TD2 (step S112). When the difference exceeds the maximum delay time TD2, the ride sharing management device 300 transmits information on an alternative transportation system to a terminal device 100 of the user (step S114). In this case, for example, a riding request of the user is treated as being cancelled, and is deleted from the riding condition information 384 automatically or with a user's agreement.

When the difference does not exceed the maximum delay time TD2, the ride sharing management device 300 determines whether the difference is a time exceeding the facility guidance reference time TD1 and not exceeding the maximum delay time TD2 (step S116).

When the difference is less than the facility guidance reference time TD1, the ride sharing management device 300 determines that the difference obtained by subtracting the desired boarding time from the estimated arrival time TA is within a scope that can be allowed by a user, and transmits an allocation completion notification to the terminal device 100 of the corresponding user (step S118). In this case, an allocation flag item of the user in the riding condition information 384 is changed to one.

On the other hand, when the difference is equal to or greater than the facility guidance reference time TD1 and is less than the maximum delay time TD2 (proceeding to FIG. 8), the ride sharing management device 300 transmits a delay arrival notification to the terminal device 100 (step S124). The delay arrival notification includes information on an estimated arrival time and the like.

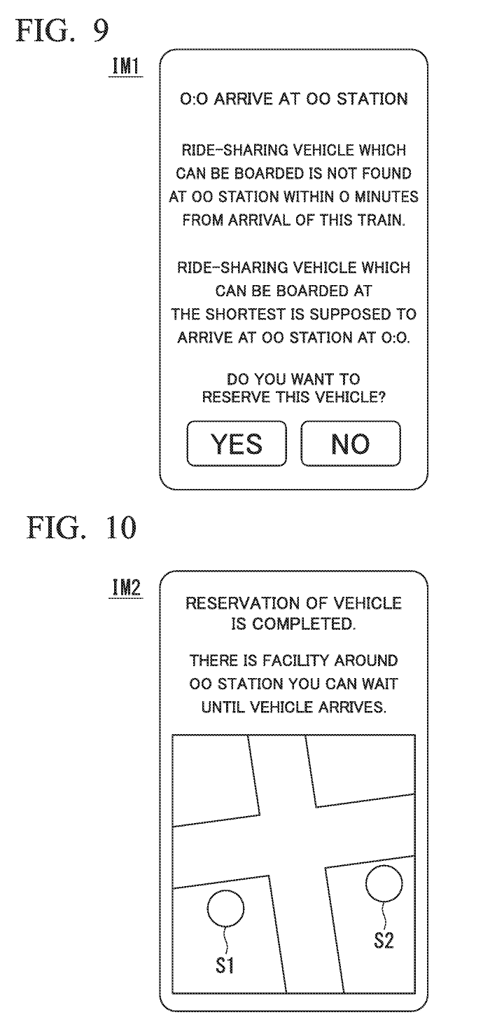

In response to this, a ride sharing application of the terminal device 100 displays a screen IM1 for obtaining a user's agreement to use a vehicle. FIG. 9 is a diagram which shows an example of the screen IM1 displayed on the terminal device 100. As shown in FIG. 9, the screen IM1 displays information indicating that there is a vehicle 200 which can arrive at an estimated arrival time later than the desired boarding time, and moreover, has a YES button and a NO button set for indicating whether or not one agrees to use a vehicle. If either button is operated by a user, the ride sharing application of the terminal device 100 transmits information indicating content of the operation to the ride sharing management device 300.

Returning to FIG. 8, the ride sharing management device 300 determines whether a user's agreement to use a vehicle has been obtained on the basis of the content received from the terminal device 100 (step S126). The ride sharing management device 300 determines that the agreement has been obtained when the YES button is operated on the terminal device 100, and determines that the agreement has not been obtained when the NO button is operated. When it is determined that a user's agreement to use a vehicle has not been obtained, processing returns to step S120 of FIG. 7. In this case, allocation to a corresponding user is skipped, and it is determined again whether allocation is possible in a next processing routine.

When it is determined that a user's agreement to use a vehicle has been obtained, the ride sharing management device 300 searches for information on a facility available to a user (step S128). The ride sharing management device 300 extracts a facility within a predetermined distance from a desired boarding place and registered as a portion of the map information 386 in advance. “Available facility” may refer to the facility extracted as described above, or may be limited to a facility in which empty seats can be secured. The ride sharing management device 300 may set a larger predetermined distance when a difference between a desired boarding time and an estimated arrival time is larger. The ride sharing management device 300 transmits information on a facility obtained as a result of the search to the terminal device 100 (step S130). This transmission of information serves as an allocation completion notification.

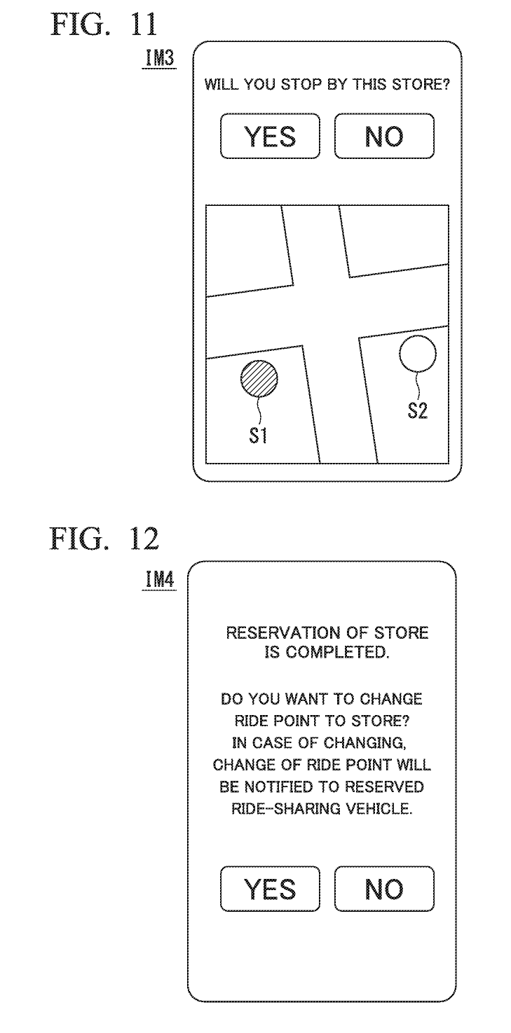

In response to this, a ride sharing application of the terminal device 100 displays a screen IM2 for obtaining a user's agreement to use facilities. FIG. 10 is a diagram which shows an example of the screen IM2. As shown in FIG. 10, information indicating that reservation of a vehicle 200 is completed is displayed, and furthermore, icons (S1 and S2) indicating the positions of available facilities on a map are displayed on the screen IM2. In correlation with these icons, information on the number of seats and vacant seats may be displayed. If either icon is operated, the ride sharing application of the terminal device 100 displays a screen IM3 for obtaining agreement to use a facility. FIG. 11 is a diagram which shows an example of the screen IM3. As shown in FIG. 11, in the screen IM3, an icon (S1) operated on a map is highlighted, and furthermore, a YES button and a NO button for indicating whether or not one agrees to use a facility are set. If either button is operated by a user, the ride sharing application of the terminal device 100 transmits information indicating content of the operation to the ride sharing management device 300.

Returning to FIG. 8, the ride sharing management device 300 determines whether a user's agreement to use a facility has been obtained on the basis of content received from the terminal device 100 (step S132). The ride sharing management device 300 determines that the agreement has been obtained when a YES button in the terminal device 100 is operated, and determines that the agreement has not been obtained when a NO button is operated. When it is determined that a user's agreement to use a facility has not been obtained, the processing returns to step S120 of FIG. 7. In this case, an allocation flag item of the corresponding user in the riding condition information 384 is changed to one. The user boards a vehicle 200 at an initial desired boarding place within a waiting time less than the maximum delay time TD2.

When it is determined that the agreement to use a facility has been obtained, the ride sharing management device 300 reserves a corresponding facility, and transmits a reservation completion notification to the terminal device 100 when the reservation is completed (step S134). The reservation of the facility may be performed automatically by accessing the facility terminal 400, and may also be performed in the form of displaying information on a facility on a display unit or by an operator making a phone call.

In response to this, the ride sharing application of the terminal device 100 displays a screen IM4 for obtaining a user's agreement to change a desired boarding place. FIG. 12 is a diagram which shows an example of the screen IM4. As shown in FIG. 12, when a facility is a store, the screen IM4 displays information indicating that reservation for the store has been completed, and furthermore, sets a YES button and a NO button for indicating whether or not one agrees to change a desired boarding place (“ride point” in FIG. 12) to the front of the store. If either button is operated by a user, the ride sharing application of the terminal device 100 transmits information indicating content of the operation to the ride sharing management device 300.

Returning to FIG. 8, the ride sharing management device 300 determines whether a user's agreement to change a desired boarding place has been obtained on the basis of the content received from the terminal device 100 (step S136). When it is determined that the agreement to change a desired boarding place has not been obtained, the processing returns to step S120 of FIG. 7. In this case, an allocation flag item of the corresponding user in the riding condition information 384 is changed to one. The user moves to an initial desired boarding place and boards the vehicle 200 after using a facility.

When it is determined that the user's agreement to change a desired boarding place is obtained, the ride sharing management device 300 updates the operation schedule information 388 by changing the desired boarding place of the corresponding user in the operation schedule information 388 to the position of a facility, and transmits a change completion notification to the terminal device 100 (step S138). In this case, the allocation flag item of the user in the riding condition information 384 is changed to one.

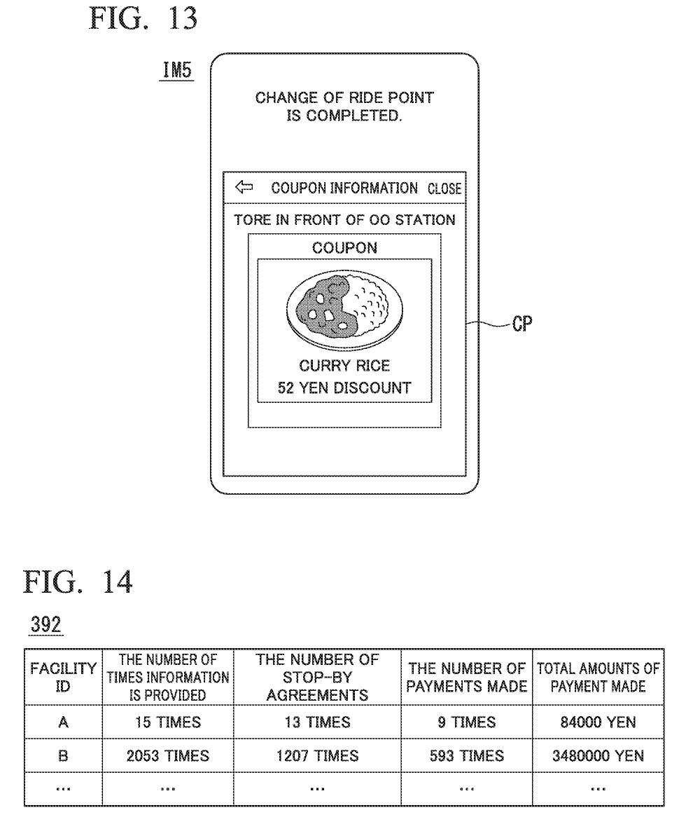

In response to this, the ride sharing application of the terminal device 100 displays a screen IM5 indicating that a desired boarding place has been changed. FIG. 13 is a diagram which shows an example of the screen IM5. As shown in FIG. 13, an electronic coupon image CP of a facility reserved in step S134 may be included in the screen IM5.

Returning to FIG. 7, after the processing of step S114, S118, or S138, or when a negative determination is obtained in step S126, S132, or S136, the ride sharing management device 300 determines whether all users have been selected (step S120). When all users have not been selected, the processing returns to step S110. When all users have been selected, the ride sharing management device 300 transmits an operation schedule which is added or updated in current processing to the vehicle 200 (step S122). As a result, processing of one routine in the flowcharts shown in FIGS. 7 and 8 ends.

As described above, the facility guidance unit 340 may dynamically transmit information on an available facility of a corresponding user to the terminal device 100 of the user according to a delay of the vehicle 200 not only at the time of searching for the vehicle 200 but also even after an operation of the vehicle 200 starts. Accordingly, processing of step S112 or later in the flowchart of FIG. 7 is periodically executed even after the vehicle 200 starts to be operated, and processing of guiding to a facility or transmitting information of an alternative transportation system in accordance with an occurrence of a delay may be performed.

[Reward]

Hereinafter, a reward system in the ride sharing system 1 will be described. When information on a facility is provided by the ride sharing management device 300 or an agreement to use a facility is obtained, an administrator of the facility pays a reward (reward) to the operator of the ride sharing system 1. When a user makes a payment at a facility, the administrator of the facility pays a reward to the operator of the ride sharing system 1.

Since a customer relationship is established between the operator of the ride sharing system 1 and the administrator of the facility, smooth system operation is realized by such a reward system being established. The reward request unit 350 determines an amount of reward for the administrator of the facility.

FIG. 14 is a diagram which shows an example of the content of the aggregate information for a reward 392. As shown in FIG. 14, the aggregate information for a reward 392 is information in which information such as the number of times information is provided, the number of stop-by agreements, the number of payments made, and a total amount of payments made is correlated with the same facility ID as in FIG. 5. The number of times information is provided is the number of times information transmission of step S130 in FIG. 8 has been performed for a corresponding facility. The number of stop-by agreements is the number of times affirmative determination has been obtained in step S132 of FIG. 8. The number of times information is provided may be counted for a plurality of facilities in a single information transmission, but the number of stop-by agreements is counted for one facility.

The number of payments made is the number of times a payment has been made by a user who has used a facility reserved by control of the ride sharing management device 300, and the total amount of payments made is a total of the amounts of the payments. These types of information are, for example, transmitted to the ride sharing management device 300 from the facility terminal 400. The reward request unit 350 updates the aggregate information for a reward 392 in accordance with the processing of the ride sharing management device 300 or on the basis of information received from the facility terminal 400.

Then, the reward request unit 350 determines an amount of reward for the administrator of a facility on the basis of some or all of the number of times information is provided, the number of stop-by agreements, the number of payments made, and the total amount of payments. The reward request unit 350, for example, generates an electronic invoice carrying a determined amount of reward and transmits it to the facility terminal 400. As a result, smooth system operation is realized.

The present invention has been described using embodiments, but the present invention is not limited to these embodiments, and various modifications and substitutions can be added in a scope not departing from the gist of the present invention.

For example, the ride sharing management device 300 may be mounted in the vehicle 200.

When the vehicle 200 is a manual driving vehicle, the communication unit 310 may communicate with a terminal device of the driver of the vehicle 200 via the network NW.

What is claimed is:

1. A ride sharing management device comprising:
a communication unit configured to communicate with a terminal device of a user;
an acquisition unit configured to acquire a riding request of the user in which riding conditions including at least a desired boarding place and a desired boarding time are defined;
an operation management unit configured to search for a vehicle which can be allocated from operation schedule information on the basis of riding conditions included in the riding request, and to decide an operation schedule of the vehicle and register it in the operation schedule information; and
a facility guidance unit configured to refer to a result of the search by the operation management unit and to transmit information on a facility available to the user to a terminal device of the user using the communication unit when the vehicle has not reached the desired boarding place by the time a first predetermined time elapses from the desired boarding time.

2. The ride sharing management device according to claim 1,
wherein the facility guidance unit transmits information on the facility available to the user to the terminal device of the user using the communication unit when the vehicle has not reached the desired boarding place by the time the first predetermined time elapses from the desired boarding time and the vehicle has reached the desired boarding place by the time a second predetermined time which is longer than the first predetermined time elapses from the desired boarding time.

3. The ride sharing management device according to claim 2,
wherein the operation management unit transmits information on an alternative transportation means to the terminal device of the user using the communication unit when a vehicle which can reach the desired boarding place by the time the second predetermined time elapses from the desired boarding time is not found.

4. The ride sharing management device according to claim 1,
wherein, when the communication unit receives information indicating the user's agreement to use a facility whose information is transmitted by the facility guidance unit from the terminal device of the user, the operation management unit changes an operation schedule of the vehicle in the operation schedule information to an operation schedule which allows the user to board the vehicle at the facility.

5. The ride sharing management device according to claim 1, further comprising:
a reward request unit configured to transmit information requesting a reward in accordance with the number of times information of a corresponding facility has been transmitted to the terminal device of the user to a facility terminal used by an administrator of the facility.

6. The ride sharing management device according to claim 1, further comprising:
a reward request unit configured to transmit information requesting a reward in accordance with the number of times information indicating that the user agrees to use a corresponding facility has been obtained from the terminal device of the user to a facility terminal used by an administrator of the facility.

7. The ride sharing management device according to claim 1, further comprising:
a reward request unit configured to transmit information requesting a reward in accordance with the number of times the user has made a payment at a facility or the amount of payment to a facility terminal used by an administrator of the facility.

8. The ride sharing management device according to claim 1,
wherein the vehicle is an automated driving vehicle.

9. A ride sharing management method, using a device including a communication unit for communicating with a terminal device of a user, comprising:
acquiring a riding request of the user in which riding conditions including at least a desired boarding place and a desired boarding time are defined,
searching for a vehicle which can be allocated from operation schedule information on the basis of riding conditions included in the riding request, determining an operation schedule of the vehicle and registering it in the operation schedule information,
referring to a result of the search, and transmitting information on a facility available to the user to the terminal device of the user using the communication unit when the vehicle has not reached the desired boarding place by the time a first predetermined time elapses from the desired boarding time.

10. A non-transitory computer-readable storage medium storing a program causing a computer of a device including a communication unit communicating with a terminal device of a user to execute steps, the steps including:
acquiring a riding request of the user in which riding conditions including at least a desired boarding place and a desired boarding time are defined;
searching for a vehicle which can be allocated from operation schedule information on the basis of riding conditions included in the riding request, determining an operation schedule of the vehicle and registering the operation schedule in the operation schedule information,
referring to a result of the search, and transmitting information on a facility available to the user to a terminal of the user using the communication unit when the vehicle has not reached the desired boarding place by the time a first predetermined time elapses from the desired boarding time.
